(19) United States
(12) Patent Application Publication
(10) Pub. No.: US 2024/0037423 A1
(43) Pub. Date: Feb. 1, 2024

(54) INFORMATION PROCESSING APPARATUS, INFORMATION PROCESSING METHOD, AND INFORMATION PROCESSING PROGRAM

(71) Applicant: AZBIL CORPORATION, Tokyo (JP)

(72) Inventor: Sei NAGASHIMA, Chiyoda-ku (JP)

(73) Assignee: AZBIL CORPORATION, Tokyo (JP)

(21) Appl. No.: 18/348,601

(22) Filed: Jul. 7, 2023

(30) Foreign Application Priority Data
Jul. 29, 2022 (JP) 2022-122055

(51) Int. Cl. G06N 5/022

(52) U.S. Cl. CPC G06N 5/022

(57) ABSTRACT

An information processing apparatus includes an index value calculation module and a parameter determination module. The index value calculation module calculates values of preset indexes for each of adjustment parameter sets to calculate regression coefficients which are used to derive a predicted value from past data. The parameter determination module selects an appropriate adjustment parameter set based on the index values calculated for each of the adjustment parameter sets and index values of neighborhood adjustment parameter sets with respect to the interested each adjustment parameter set.

### CROSS-REFERENCE TO RELATED APPLICATIONS

The present application is based on and claims priority to Japanese Application No. 2022-122055, filed Jul. 29, 2022, the entire contents of which are incorporated herein by reference.

### BACKGROUND

### 1. Field of the Disclosure

The present disclosure relates to an information processing apparatus, an information processing method, and an information processing program.

### 2. Description of the Related Art

Until now, processing to analyze time series data and to execute data prediction based on the analysis has been performed for the purpose of preventing accidents in manufacturing sites handling hazardous substances, and so on. To increase accuracy of the prediction, parameters of a prediction model need to be adjusted.

However, work of adjusting the parameters takes a lot of labor and time because the work is carried out through repetition of trials and errors based on properties of prediction trends and knowledges of engineers. To cope with that problem, there is known a method of carrying out the parameter adjustment work with the AI (Artificial Intelligence) technique.

Known examples of the related art include a method of estimating dynamic parameters based on irregular input data and output data with constraints given as static parameters calculated based on regular output data and corresponding regular input data (see, e.g., Japanese Unexamined Patent Application Publication No. 2004-062440), and a method of, for time series data, optimizing a parameter set defining multiple inharmonic signals in a round-robin fashion (see, e.g., International Publication No. 2020/178919).

However, the above-mentioned examples of the related art cannot avoid a possibility that, in evaluating the estimated parameters or each parameter set, an evaluation value may be calculated with use of abnormal data such an outlier. This leads to a problem causing a possibility that an improper parameter set may be determined with the unexpected abnormal data.

### SUMMARY

To solve the above-described problem and to achieve an object, the present disclosure provides an information processing apparatus including an index value calculation module that calculates values of preset indexes for each of adjustment parameter sets to calculate regression coefficients which are used to derive a predicted value from past data, and a parameter determination module that selects an appropriate adjustment parameter set based on the index values calculated for each of the adjustment parameter sets and index values of neighborhood adjustment parameter sets with respect to the interested each adjustment parameter set.

The present disclosure has an advantageous effect that, since, in evaluating the parameter set, the concept of “distance (time position)” with respect to the parameter set or a data set is introduced to the evaluation, determination of an improper model parameter set attributable to the unexpected abnormal data can be avoided.

### BRIEF DESCRIPTION OF THE DRAWINGS

FIG. 1 illustrates outlines of methods of calculating a predicted value and regression coefficients in information processing according to an embodiment;

FIG. 2 illustrates an outline of adjustment parameters in the information processing according to the embodiment;

FIG. 3 is an explanatory view illustrating an outline of an information processing method according to Embodiment 1;

FIG. 4 illustrates an example of configuration of an information processing apparatus according to Embodiment 1;

FIG. 5 illustrates an outline of an index value in the information processing according to Embodiment 1;

FIG. 6 illustrates an outline of an index value in the information processing according to Embodiment 1;

FIG. 7 illustrates an outline of an index value in the information processing according to Embodiment 1;

FIG. 8 illustrates an outline of processing when an appropriate adjustment parameter set is selected in consideration of neighborhood adjustment parameter sets in the information processing according to Embodiment 1;

FIG. 9 illustrates an overall system flow in a specific example of the information processing according to Embodiment 1;

FIG. 10 illustrates an example of various settings as a premise in the specific example of the information processing according to Embodiment 1;

FIG. 11 illustrates an example of a selection result for the adjustment parameter sets in the specific example of the information processing according to Embodiment 1;

FIG. 12 illustrates an example of a selection result for the adjustment parameter sets in the specific example of the information processing according to Embodiment 1;

FIG. 13 illustrates an example of a selection result for the adjustment parameter sets in the specific example of the information processing according to Embodiment 1;

FIG. 14 illustrates an example of a selection result for the adjustment parameter sets in the specific example of the information processing according to Embodiment 1;

FIG. 15 is a flowchart illustrating an example of processing procedures according to Embodiment 1;

FIG. 16 illustrates an example of results of predictions with the information processing according to Embodiment 1;

FIG. 17 is an explanatory view illustrating an outline of an information processing method according to Embodiment 2;

FIG. 18 illustrates an example of configuration of an information processing apparatus according to Embodiment 2;

FIG. 19 illustrates an overall system flow in a specific example of information processing according to Embodiment 2;

FIG. 20 illustrates an example of a method of calculating a mean RMS error in the specific example of the information processing according to Embodiment 2;

FIG. 21 is a flowchart illustrating processing procedures according to Embodiment 2;

FIG. 22 illustrates an example of a prediction result obtained with the information processing according to Embodiment 2; and

FIG. 23 illustrates an example of hardware configuration.

### DETAILED DESCRIPTION

Embodiments of an information processing apparatus, an information processing method, and an information processing program according to this application will be described in detail below with reference to the drawings. While two embodiments are described for the information processing apparatus according to this application, the information processing apparatus, the information processing method, and the information processing program according to this application are not limited by those embodiments.

### Principle

### 1. Introduction

Functions of the information processing apparatus according to an embodiment and an autoregression model as an output destination of the information processing apparatus will be described below. The autoregression model estimates a predicted value in the future one or more arbitrary steps ahead by regressively shifting a predicted value in the future one step ahead with respect to given time series data into a time series in the past. The information processing apparatus according to the embodiment searches for an adjustment parameter set, described later, which provides proper prediction at each point in time with respect to the given time series data, and outputs the adjustment parameter set to the autoregression model, for example.

### 2. Method of Calculating Predicted Value

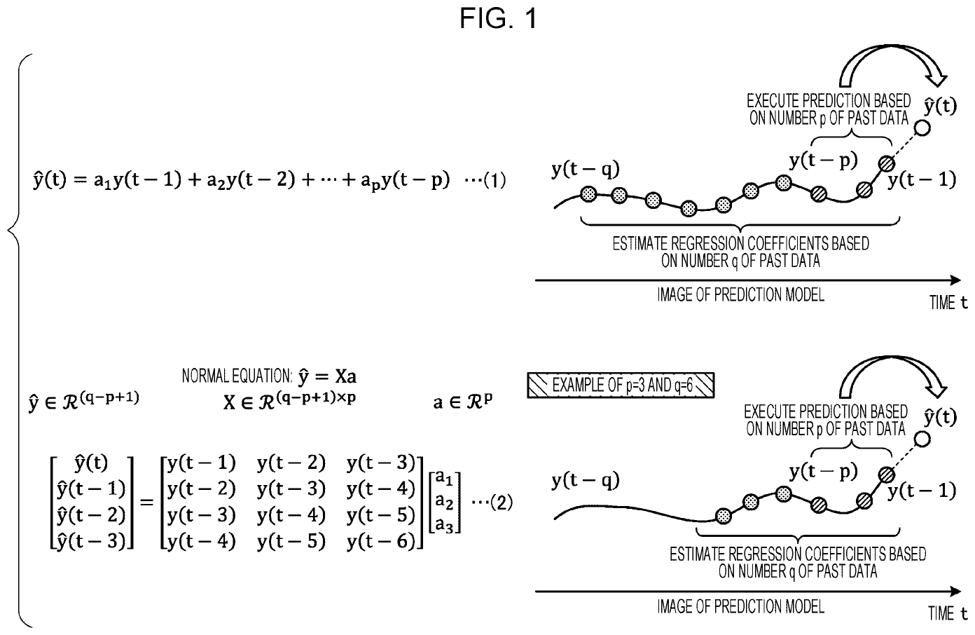

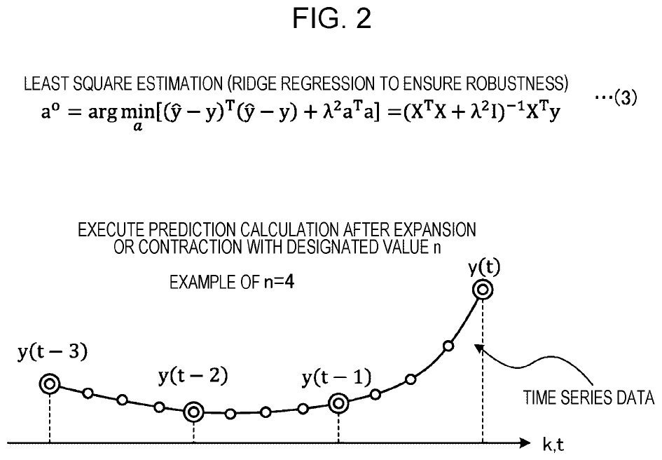

A method of calculating a predicted value with the autoregression model according to the embodiment and adjustment parameters to calculate regression coefficients used in that method will be described below with reference to formulae and drawings. FIG. 1 illustrates outlines of the methods of calculating the predicted value and the regression coefficients in information processing according to the embodiment. FIG. 2 illustrates an outline of the adjustment parameters in the information processing according to the embodiment.

### 2-1. Predicted Value and Regression Coefficients

The method of calculating the predicted value is first described. The predicted value is calculated by applying weights as the regression coefficients to an arbitrary number (p) of past data back from a current value and by adding the weighted past data. Here, the method of calculating the predicted value based on the number p of the past data is expressed by a formula (1) in FIG. 1. The regression coefficients are calculated, by the regularized least square method, as values best fitting to an arbitrary number (q) of past data. The method of calculating the regression coefficients is expressed by a formula (2) in FIG. 1.

For instance, the formula (2) in FIG. 1 expresses a normal equation for obtaining the regression coefficients (a1, a2, a3) in the case of, for example, “p=3 and q=6”. In other words, the predicted value is calculated from data given as a reference value based on both the number 3 (p) of the past data and the regression coefficients (a1, a2, a3), and the regression coefficients (a1, a2, a3) are estimated from the data given as a reference value by using six past data.

### 2-2. Adjustment Parameters

The adjustment parameters used to calculate the above-described regression coefficients will be described below with reference to a formula. There are four types of adjustment parameters, namely A and n as well as the above-mentioned p and q. One set of those four combined adjustment parameters is referred to as an adjustment parameter set.

Here, the adjustment parameter A is a weight for regularization in a process of calculating the above-mentioned regression coefficients and is a robust parameter for stabilizing calculation. Least square estimation with ridge regression adopting A to ensure robustness is expressed by a formula (3) in FIG. 2. The adjustment parameter n is an arbitrary value to expand or contract the past data in calculation of the predicted value and is a parameter for adjusting a sampling period for data used in the prediction (see FIG. 2).

In the example of FIG. 2, there are, for example, 13 time points each serving as a reference in the time series data in the calculation of the predicted value. Because of the adjustment parameter of “n=4”, however, four among the 13 time points are extracted at equal intervals, and calculation for the prediction is performed by using the extracted time points.

### Embodiment 1

### 1. Outline of Information Processing Method

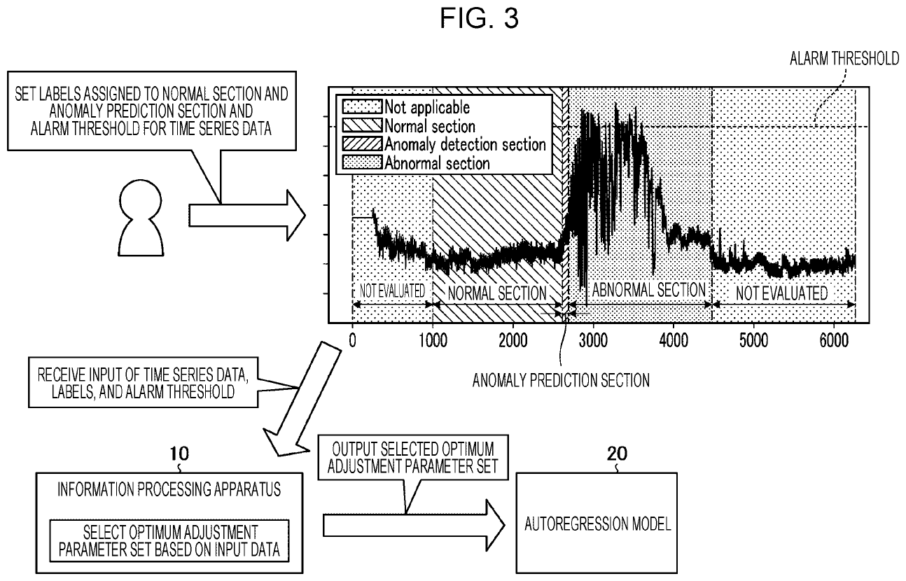

An outline of the information processing method executed by the information processing apparatus 10 according to Embodiment 1 is first described with reference to FIG. 3. FIG. 3 is an explanatory view illustrating the outline of the information processing method according to Embodiment 1. The description with reference to FIG. 3 is made about an example of information processing when the adjustment parameter set providing, for the given time series data, proper prediction at the time points each serving as the reference in the calculation of the predicted value within an evaluation target is selected and is output to the outside.

In the example illustrated in FIG. 3, the information processing apparatus 10 selects an optimum adjustment parameter set in response to input of the time series data, labels assigned to a normal section and an anomaly prediction section, and an alarm threshold, and outputs the selected result. The information processing apparatus 10 is implemented by, for example, a computer or a cloud system.

The information processing apparatus 10 receives the input of the time series data, the labels assigned to the normal section and the anomaly prediction section, and the alarm threshold, evaluates prediction results for all candidate adjustment parameter sets with respect to all the time points within the evaluation target based on the received information, selects the optimum adjustment parameter set, and outputs the optimum adjustment parameter set to the outside.

In more detail, the information processing apparatus 10 first receives the time series data, the labels assigned to the normal section and the anomaly prediction section of the time series data, and the alarm threshold that are input by, for example, an engineer. For instance, the information processing apparatus 10 receives, as the time series data, past time series data of an apparatus that is a target for which the predicted value is to be calculated.

Furthermore, for instance, the information processing apparatus 10 receives the labels assigned to the normal section and the anomaly prediction section of the time series data. Here, the normal section is a section of the time series data in which the time series data after an arbitrary period of time relative to each point in time has a value not exceeding the alarm threshold described later. On the other hand, the anomaly prediction section is a section of the time series data in which the time series data after an arbitrary period of time relative to each point in time has a value exceeding the alarm threshold.

In addition, for instance, the information processing apparatus 10 receives the alarm threshold that is set by, for example, the engineer. Here, the alarm threshold is set such that, in a process of obtaining the optimum adjustment parameter set, a prediction result not exceeding the alarm threshold is obtained in the normal section and a prediction result exceeding the alarm threshold is obtained in the anomaly prediction section. Setting of the above-mentioned assignment of the labels and setting of the alarm threshold are performed by, for example, the engineer before the information processing is started by the information processing apparatus 10.

Upon receiving the input of the time series data, the labels assigned to the normal section and the anomaly prediction section, and the alarm threshold, the information processing apparatus 10 calculates values of preset indexes for all the candidate adjustment parameter sets with respect to all the time points. For instance, the information processing apparatus 10 calculates, in accordance with the above-described input information, values of four indexes, namely an RMS (Root Mean Square) error, a threshold determination result, an anomaly detection success rate, and a normal section prediction success rate described later, for all the candidate adjustment parameter sets with respect to all the time points.

Then, the information processing apparatus 10 executes preset processing based on the calculated index values and selects the optimum adjustment parameter set. For instance, the information processing apparatus 10 executes processing to select the parameter set with a maximum anomaly detection success rate, processing (described later) to determine parameter effectiveness, and so on in order based on the calculated four index values, thereby selecting the optimum adjustment parameter set. Finally, the information processing apparatus 10 outputs the selected optimum adjustment parameter set to the outside. The information processing apparatus 10 outputs the selected optimum adjustment parameter set to an external device, namely an autoregression model 20, for example.

As described above, the information processing apparatus 10 selects the optimum adjustment parameter set in response to the input of the time series data, the labels assigned to the normal section and the anomaly prediction section, and the alarm threshold, and outputs the selected result to the outside. Consequently, the autoregression model 20 can obtain the optimum adjustment parameter set used to calculate the predicted value.

### 2. Configuration of Information Processing Apparatus 10

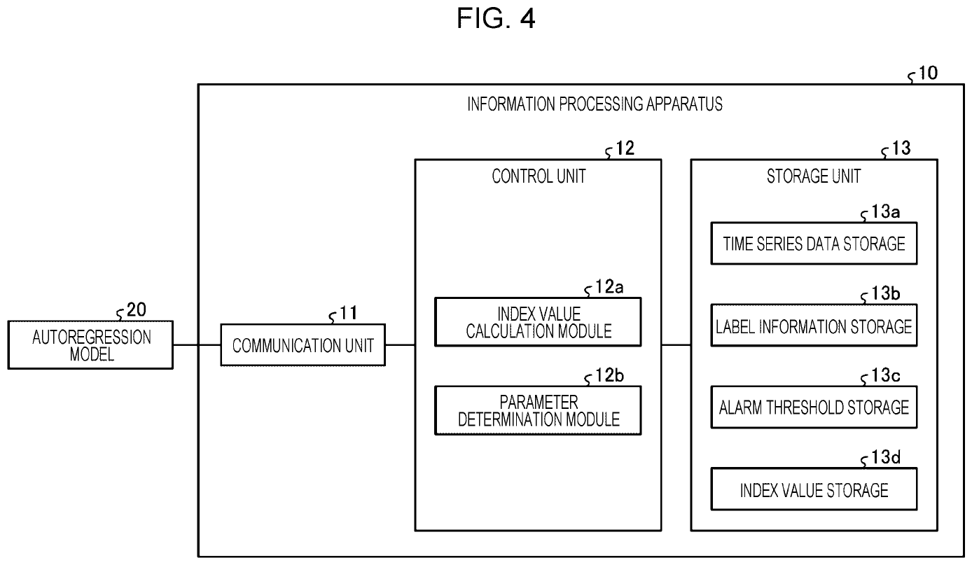

A configuration of the information processing apparatus 10 according to Embodiment 1 will be described below with reference to FIG. 4. FIG. 4 illustrates an example of the configuration of the information processing apparatus 10 according to Embodiment 1. As illustrated in FIG. 4, the information processing apparatus 10 according to Embodiment 1 includes a communication unit 11, a control unit 12, and a storage unit 13. The information processing apparatus 10 and the autoregression model 20 are connected to be able to communicate with each other by wire or wirelessly.

The communication unit 11 is implemented by, for example, an NIC (Network Interface Card). The communication unit 11 is connected to the autoregression model 20 by wire or wirelessly to transmit and receive information to and from the autoregression model 20. Furthermore, the time series data, label information, and the alarm threshold, for example, are also received from the outside via the communication unit 11.

The storage unit 13 is implemented by, for example, a storage device such as a RAM (Random Access Memory) or a hard disk. The storage unit 13 stores data and programs necessary in various processes executed by the control unit 12. The storage unit 13 includes a time series data storage 13a, a label information storage 13b, an alarm threshold storage 13c, and an index value storage 13d as examples that are especially closely related to this Embodiment 1.

The time series data storage 13a stores the time series data obtained by monitoring a target apparatus in time series. For instance, the time series data storage 13a stores, as the time series data, data recording a measured value, such as a temperature of the target apparatus, which is obtained by monitoring the target apparatus in time series, together with a time of the measurement.

The label information storage 13b stores, with respect to the time series data, information of the labels attached to the time series data corresponding to the normal section and the anomaly prediction section. For instance, in the time series data of the target apparatus, the measured value during normal operation of the apparatus is assigned with the label indicating the normal section, and the measured value immediately before the occurrence of abnormal operation of the apparatus is assigned the label indicating the anomaly prediction section. The label information storage 13b stores the information of the labels attached to individual sets of the time series data.

The alarm threshold storage 13c stores the alarm threshold that is set to determine whether an alarm is to be issued for the measured value of interest. For instance, the alarm threshold storage 13c stores the alarm threshold that is set to determine whether an alarm is to be issued for the measured value of, for example, the temperature of the target apparatus.

The time series data, the label information, and the alarm threshold, described above, need to be previously stored before the selection of the optimum adjustment parameter set is started by the control unit 12. Those three data are stored in the corresponding storages via the communication unit 11. The operation of storing the data may be manually performed by, for example, the engineer, or may be automatically performed from, for example, a device monitoring the target apparatus.

The index value storage 13d stores individual index values calculated by an index value calculation module 12a described later. For instance, the index value storage 13d stores the index values calculated for all the candidate adjustment parameter sets with respect to all the time points of the received time series data.

The control unit 12 is implemented by, for example, a CPU (Central Processing Unit) or an MPU (Micro Processing Unit) that executes various programs, stored in the storages of the information processing apparatus 10, while a RAM is used as a working area. Alternatively, the control unit 12 is implemented by, for example, an integrated circuit such as an ASIC (Application Specific Integrated Circuit) or an FPGA (Field Programmable Gate Array). The control unit 12 includes the index value calculation module 12a and a parameter determination module 12b.

The index value calculation module 12a calculates values of the preset indexes for each of the adjustment parameter sets to calculate the regression coefficients that are used to derive a predicted value from the past data. The index value calculation module 12a stores the calculated index values in the index value storage 13d.

For instance, the index value calculation module 12a calculates the index values for all the candidate adjustment parameter sets with respect to all the time points of the received time series data based on respective data stored in the time series data storage 13a, the label information storage 13b, and the alarm threshold storage 13c, and stores the calculated index values in the index value storage 13d.

Moreover, the index value calculation module 12a may calculate, as the index values, the root mean square error between a predicted value corresponding to a time point in the past data, the time point being a reference in the calculation of the predicted value, and the past actual data, a difference between the predicted value corresponding to the time point and the preset threshold, the anomaly detection success rate that is a ratio of one or more anomaly prediction sections each including the time point corresponding to the predicted value, for which anomaly prediction has succeeded, to all the anomaly prediction sections in the past data, and the normal section prediction success rate that is a ratio of the number of the time points corresponding to the predicted values, for which normal prediction has succeeded, to the total number of the time points in one or more normal sections of the past data.

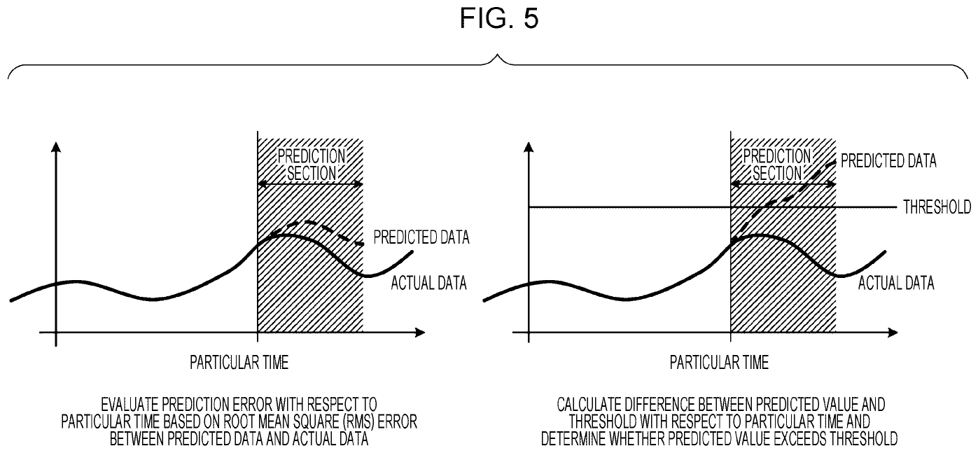

Outlines of the above-mentioned various index values are described here with reference to FIGS. 5 to 7. FIGS. 5 to 7 each illustrate the outline of the index value in the information processing according to Embodiment 1.

The index value calculation module 12a calculates the root mean square (RMS) error between the predicted value corresponding to a particular time point and the actual past data. As the root mean square error is smaller, this indicates that prediction accuracy of the predicted value is higher. Accordingly, from the result of calculating the root mean square error, the information processing apparatus 10 can evaluate the prediction error at the particular time point and can select the optimum adjustment parameter set (see FIG. 5).

The index value calculation module 12a further calculates the difference between the predicted value corresponding to the particular time point and the preset threshold. From the calculation result, the index value calculation module 12a can determine whether the predicted value exceeds the threshold (see FIG. 5).

The index value calculation module 12a further calculates the anomaly detection success rate that is the ratio of one or more anomaly prediction sections each including the time point corresponding to the predicted value, for which the anomaly prediction has succeeded, to all the anomaly prediction sections in the past data. From the calculation result, the information processing apparatus 10 can evaluate whether the above-mentioned predicted value corresponding to the time point in the anomaly prediction section exceeds the threshold (namely, the anomaly prediction), and hence can select the optimum adjustment parameter set.

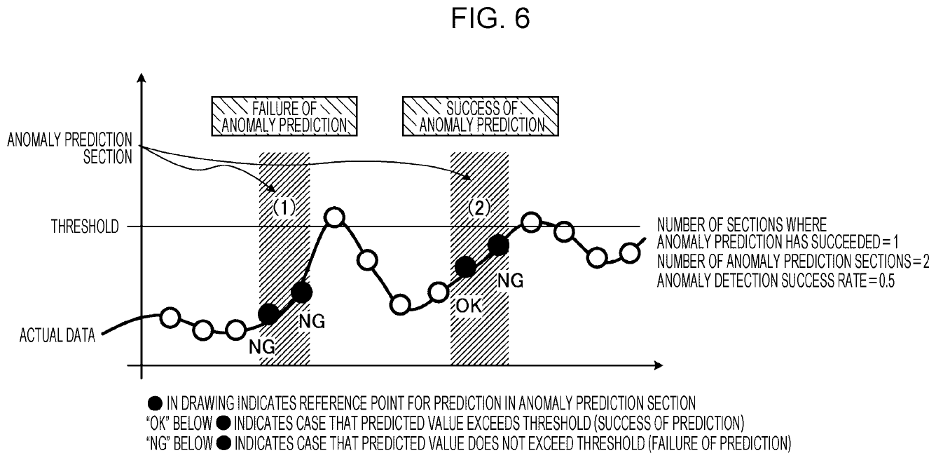

In the example of FIG. 6, two anomaly prediction sections exist in the past data, and two time points exist in each of an anomaly prediction section (1) and an anomaly prediction section (2). The prediction has failed for both the predicted values corresponding to the time points in the anomaly prediction section (1) while the prediction has succeeded for only one of the predicted values corresponding to the time points in the anomaly prediction section (2). Accordingly, it can be said that the anomaly prediction section (2) is the anomaly prediction section including the time point corresponding to the predicted value for which the anomaly prediction has succeeded.

Thus, because the number of sections in which the anomaly prediction has succeeded is 1 and the number of all the anomaly prediction sections is 2, the index value calculation module 12a in the example of FIG. 6 calculates, as ½=0.5, the anomaly detection success rate that is the ratio of one or more anomaly prediction sections each including the time point corresponding to the predicted value, for which the anomaly prediction has succeeded, to all the anomaly prediction sections in the past data.

The index value calculation module 12a further calculates the normal section prediction success rate that is the ratio of the number of the time points corresponding to the predicted values, for which the normal prediction has succeeded, to the total number of the time points in one or more normal sections of the past data. From the calculation result, the information processing apparatus 10 can evaluate whether the above-mentioned predicted values corresponding to the time points in the normal sections do not exceed the threshold (namely, the normal prediction), and hence can select the optimum adjustment parameter set.

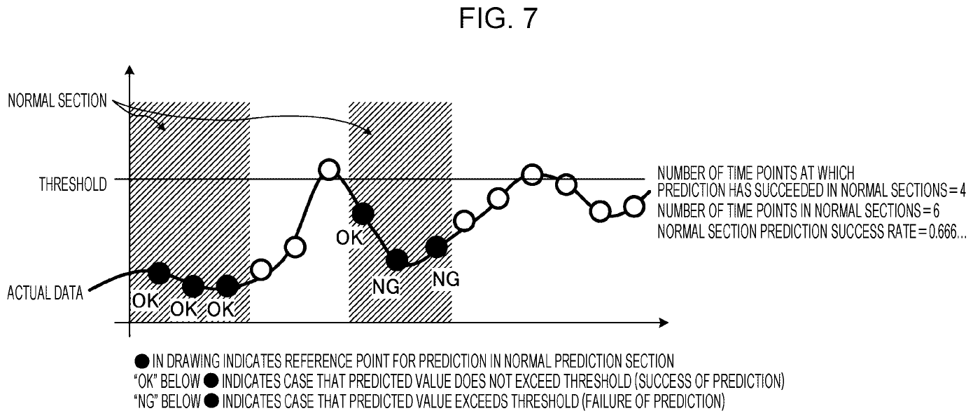

In the example of FIG. 7, the total number of the time points in the normal sections of the past data is 6. Among those time points, the number of the time points corresponding to the predicted values for which the normal prediction has succeeded is 4. Accordingly, the index value calculation module 12a in the example of FIG. 7 calculates, as 4/6=0.666 . . . , the normal section prediction success rate that is the ratio of the number of the time points corresponding to the predicted values, for which the normal prediction has succeeded, to the total number of the time points in the normal sections.

For instance, the index value calculation module 12a calculates the above-described four index values for all the candidate adjustment parameter sets with respect to all the time points of the time series data based on the respective data stored in the time series data storage 13a, the label information storage 13b, and the alarm threshold storage 13c, and stores the calculated index values in the index value storage 13d.

The parameter determination module 12b selects an appropriate adjustment parameter set based on the index values calculated for each of the adjustment parameter sets and the index values of neighborhood adjustment parameter sets with respect to the interested each adjustment parameter set.

Furthermore, the parameter determination module 12b selects the appropriate adjustment parameter set based on the index values of the neighborhood adjustment parameter sets that are given as adjustment parameter sets in each of which a numerical value of one of elements in the adjustment parameter set is changed to adjacent one among candidates that are set as numerical values of the one element.

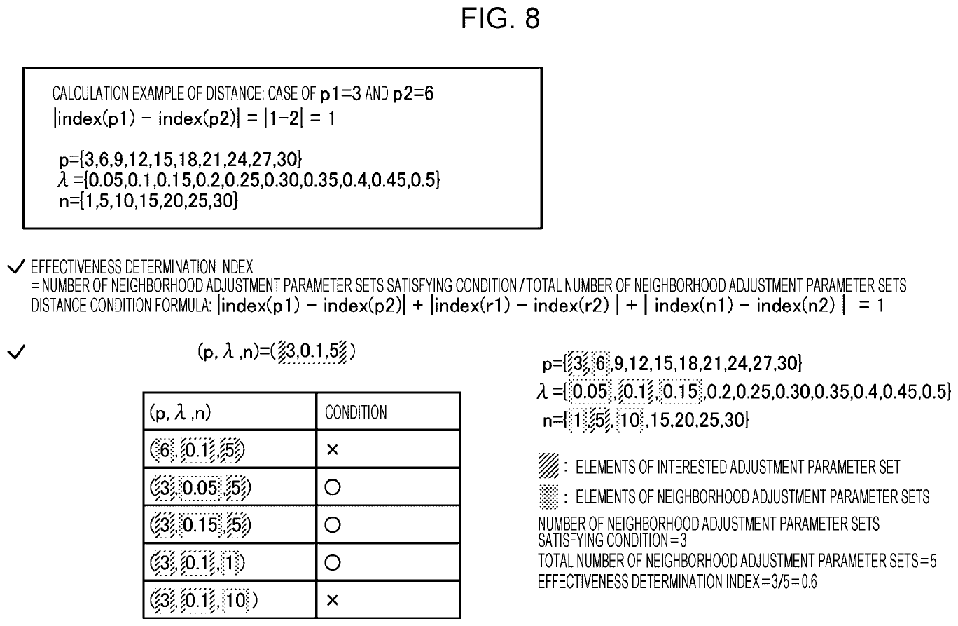

An effectiveness determination index used by the parameter determination module 12b to select the appropriate adjustment parameter set based on the index values of the neighborhood adjustment parameter sets and an effectiveness determination process of calculating the effectiveness determination index will be described below with reference to FIG. 8. FIG. 8 illustrates an outline of processing when the appropriate adjustment parameter set is selected based on the neighborhood adjustment parameter sets in the information processing according to Embodiment 1.

In the example of FIG. 8, ten candidates of 3 to 30 as numerical values of the element p of the adjustment parameter set, ten candidates of 0.05 to 0.5 as numerical values of the element A, and seven candidates of 1 to 30 as numerical values of the element n are set in the information processing apparatus 10. Because the adjustment parameter q is set to be three times p, it is omitted in the example of FIG. 8.

Here, looking at, for example, one interested adjustment parameter set (p, λ, n)=[3, 0.1, 5], (p, λ, n)=[6, 0.1, 5] is one of examples of the neighborhood adjustment parameter sets in which the numerical value 3 of p is changed to the numerical value 6 that is adjacent one among the other candidates of p. Because there are four adjacent values to be changed regarding the numerical values of the other elements than those of p, the parameter determination module 12b derives five neighborhood adjustment parameter sets, illustrated in FIG. 8, as the neighborhood adjustment parameter sets with respect to the interested adjustment parameter set.

The parameter determination module 12b in Embodiment 1 executes a concrete process of deriving the neighborhood adjustment parameter sets based on a distance condition formula illustrated in FIG. 8. In this case, the parameter determination module 12b assigns indexes of 1 to the element number for each element of the adjustment parameter set. Moreover, the parameter determination module 12b executes calculation using index(p1) to express the index of each element (for example, p) and calculates a distance between the elements as |index(p1)−index(p2)|.

Then, the parameter determination module 12b determines whether the index values for each of the five neighborhood adjustment parameter sets satisfy the preset condition. In the example of FIG. 8, three among the five neighborhood adjustment parameter sets satisfy the condition. Thus, the parameter determination module 12b calculates, as ⅗=0.6, the effectiveness determination index that is a ratio of the number of the neighborhood adjustment parameter sets satisfying the condition to the total number of the neighborhood adjustment parameter sets with respect to the interested adjustment parameter set.

For instance, the parameter determination module 12b selects the adjustment parameter set based on the effectiveness determination index that is calculated from both the index values of each adjustment parameter set, those index values being stored in the index value storage 13d, and the index values of the neighborhood adjustment parameter sets in each of which the numerical value of one of the elements in the interested each adjustment parameter set is changed to adjacent one among the candidates that are set as the numerical values of the one element.

### 3. Specific Example of Information Processing

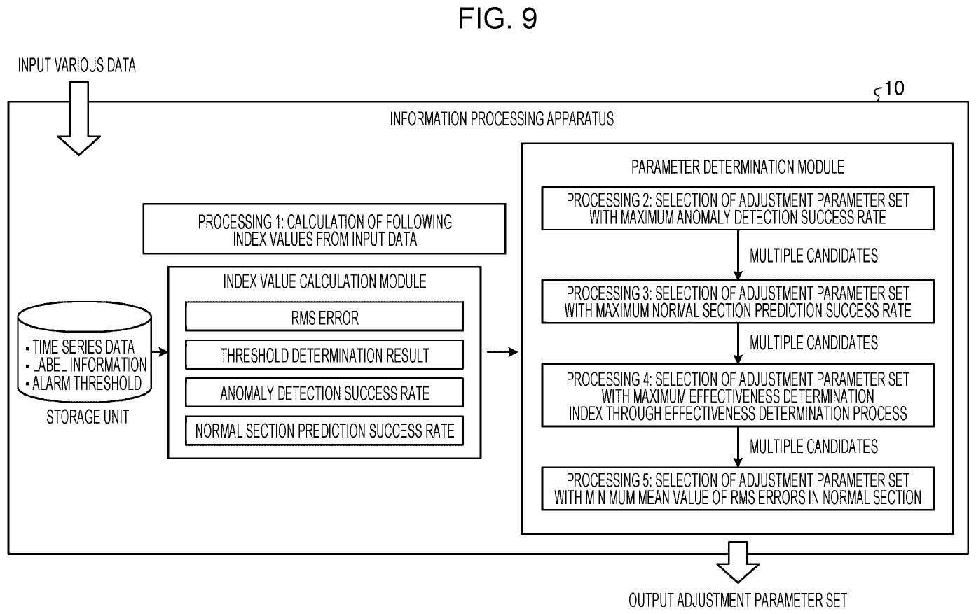

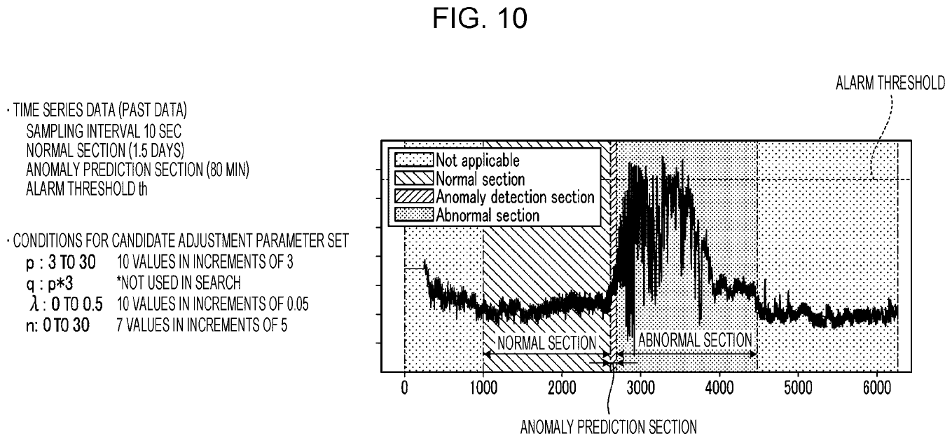

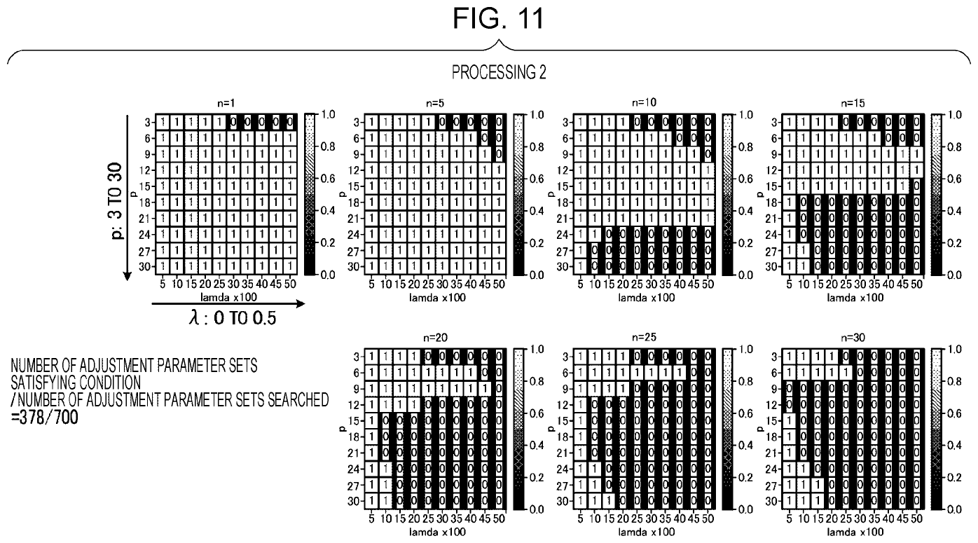

A specific example of the information processing according to Embodiment 1 will be described below with reference to FIGS. 9 to 14. FIG. 9 illustrates an overall system flow in the specific example of the information processing according to Embodiment 1. FIG. 10 illustrates an example of various settings as a premise in the specific example of the information processing according to Embodiment 1. FIGS. 11 to 14 each illustrate an example of a selection result for the adjustment parameter sets in the specific example of the information processing according to Embodiment 1. In the following, after describing the flow of the information processing in the information processing apparatus 10, a specific example of a process of selecting the adjustment parameter set is described.

### 3-1. Flow of Information Processing

The overall system flow in the specific example of the information processing apparatus 10 is first described with reference to FIG. 9. For instance, in the information processing apparatus 10, the time series data, the label information, and the alarm threshold are input from the outside, and the input data are stored in the corresponding storages.

Then, the index value calculation module 12a calculates, for example, the RMS error, the threshold determination result, the anomaly detection success rate, and the normal section prediction success rate based on the data stored in the storages for each of all preset candidates for the adjustment parameter sets, and stores the calculated results in the index value storage 13d.

The parameter determination module 12b first executes, based on the index values stored in the index value storage 13d, Processing 2: selection of the adjustment parameter set with the maximum anomaly detection success rate. If there are multiple selected candidates, the parameter determination module 12b then executes Processing 3: selection, from among those candidates, of the adjustment parameter set with the maximum normal section prediction success rate.

If multiple candidates are selected by Processing 3, the parameter determination module 12b then executes Processing 4: selection, from among those candidates, of the adjustment parameter set with the maximum effectiveness determination index through the effectiveness determination process. If there are multiple selection results, the parameter determination module 12b finally executes Processing 5: selection, from among those candidates, of the adjustment parameter set with a minimum mean value of the RMS errors in the normal section, thus selecting the optimum adjustment parameter set. Thereafter, the information processing apparatus 10 outputs the adjustment parameter set selected by the parameter determination module 12b to the outside.

Note that FIG. 9 illustrates an example of the information processing apparatus according to Embodiment 1, and that a series of the processes can be executed while the order of the processes is partly exchanged, because the processing 2 to the processing 5 are independent of one another.

### 3-2. Settings as Premise for Information Processing

Various settings as the premise in the specific example of the information processing according to Embodiment 1 will be described below with reference to FIG. 10. In this specific example, a sampling interval for the time series data is set to 10 sec, data corresponding to 1.5 days in the time series data is labeled as the normal section, and data corresponding to 80 min is labeled as the anomaly prediction section. The alarm threshold is set to th.

As conditions for candidate adjustment parameter sets, it is assumed that the element p has 10 values of 3 to 30 in increments of 3, the element q (not used in search) has values three time those of the element p, the element A has 10 values of 0 to 0.5 in increments of 0.05, and the element n has 7 values of 0 to 30 in increments of 5. Thus, the index value calculation module 12a calculates the index values for each of the total 700 candidate adjustment parameter sets with respect to all the time points within the evaluation target.

### 3-3. Adjustment Parameter Set Selection Process

Selection results of the adjustment parameter sets through various processes in the specific example of the information processing according to Embodiment 1 will be described below with reference to FIGS. 11 to 14. For instance, the parameter determination module 12b executes Processing 2 to Processing 5 in order based on the index values stored in the index value storage 13d and selects the optimum adjustment parameter set (see FIG. 9).

First, the parameter determination module 12b executes Processing 2: selection of the adjustment parameter set with the maximum anomaly detection success rate and obtains a result illustrated in FIG. 11. According to the result, among the total 700 candidate adjustment parameter sets having been searched, 378 adjustment parameter sets satisfy the condition of Processing 2 and are selected. In other words, those 378 adjustment parameter sets are selected as the adjustment parameter sets with the maximum anomaly detection success rate of “1”. Because there are multiple selection results, the parameter determination module 12b shifts to Processing 3.

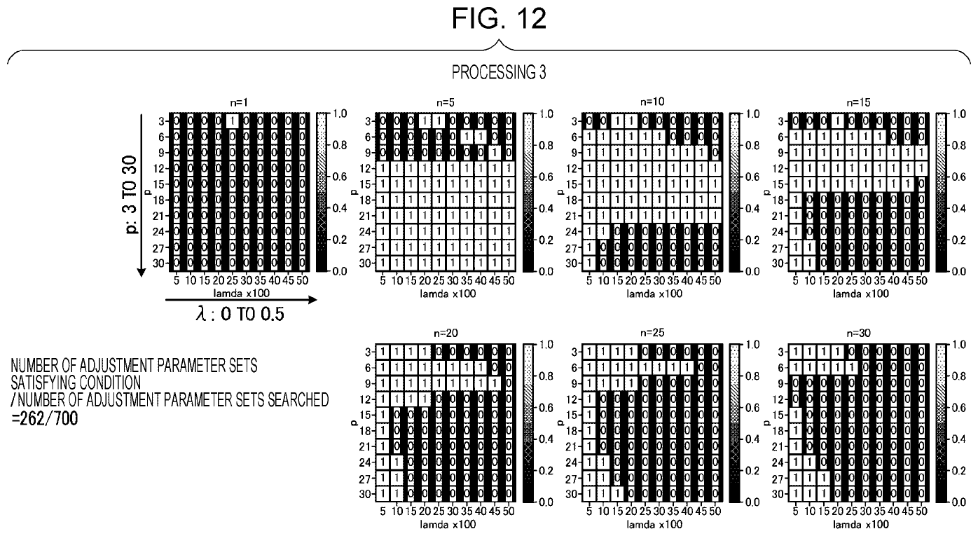

Then, the parameter determination module 12b executes Processing 3: selection of the adjustment parameter set with the maximum normal section prediction success rate and obtains a result illustrated in FIG. 12. According to the result, among the 378 adjustment parameter sets having been selected in Processing 2, 262 adjustment parameter sets satisfy the condition of Processing 3 and are selected. In other words, in a similar manner to that in the above-described Processing 2, 262 adjustment parameter sets are selected as the adjustment parameter sets with the maximum normal section prediction success rate of “1”. Because there are multiple selection results, the parameter determination module 12b shifts to Processing 4.

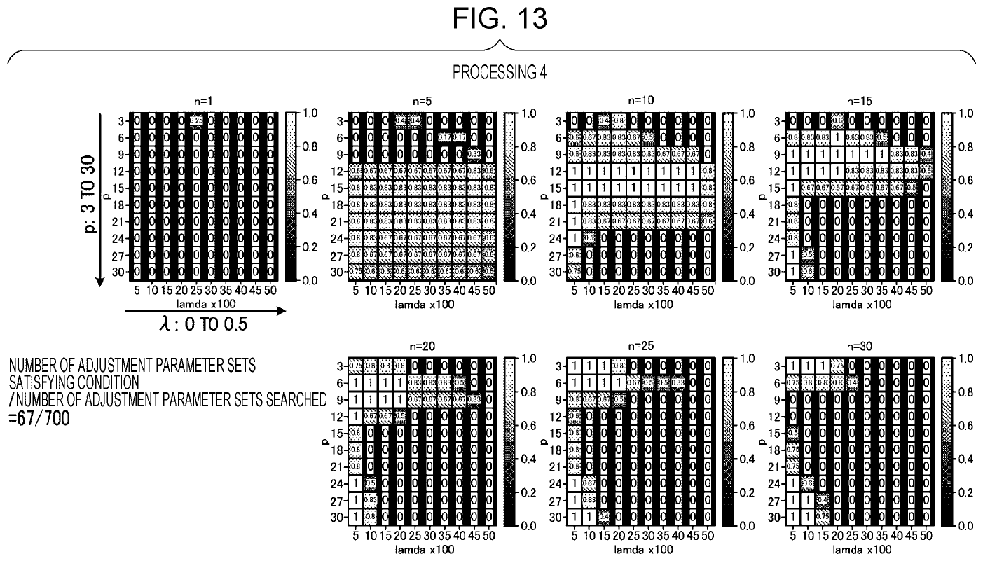

Then, the parameter determination module 12b executes Processing 4: selection of the adjustment parameter set with the maximum effectiveness determination index through the effectiveness determination process and obtains a result illustrated in FIG. 13. According to the result, among the 262 adjustment parameter sets having been selected in Processing 3, 67 adjustment parameter sets satisfy the condition of Processing 4 and are selected. In other words, in a similar manner to that in the above-described Processing 2 and 3, 67 adjustment parameter sets are selected as the adjustment parameter sets with the maximum effectiveness determination index of “1”. Because there are multiple selection results, the parameter determination module 12b shifts to Processing 5.

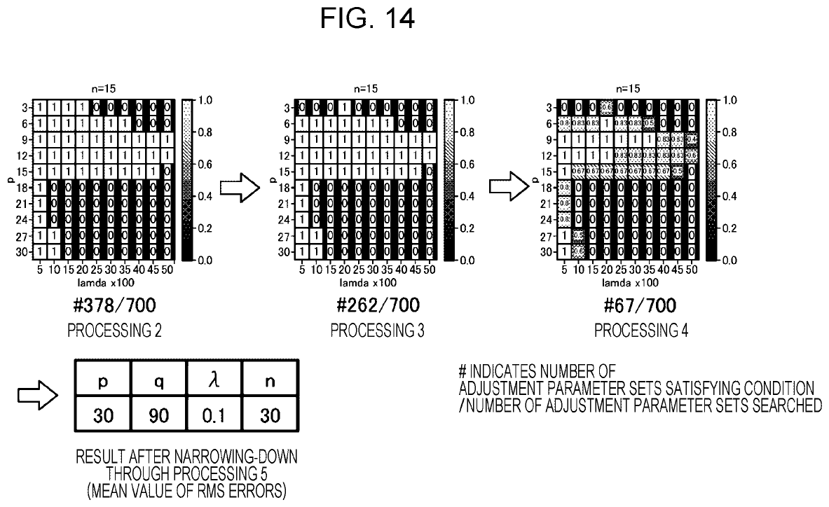

Finally, the parameter determination module 12b executes Processing 5: selection of the adjustment parameter set with the minimum mean value of the RMS errors in the normal section and obtains a result illustrated in FIG. 14. According to the result, among the 67 adjustment parameter sets having been selected in Processing 4, the adjustment parameter set (p, q, λ, n)=[30, 90, 0.1, 30] satisfies the condition of Processing 5 and is selected.

Through the above-described series of the processes, the parameter determination module 12b can select the adjustment parameter set satisfying all the conditions of Processing 2 to Processing 5. In other words, the parameter determination module 12b can properly execute the anomaly prediction and the normal prediction and can select the optimum adjustment parameter set that is not affected by an outlier and that has a small error between the predicted value and the actual data.

### 4. Processing Procedures

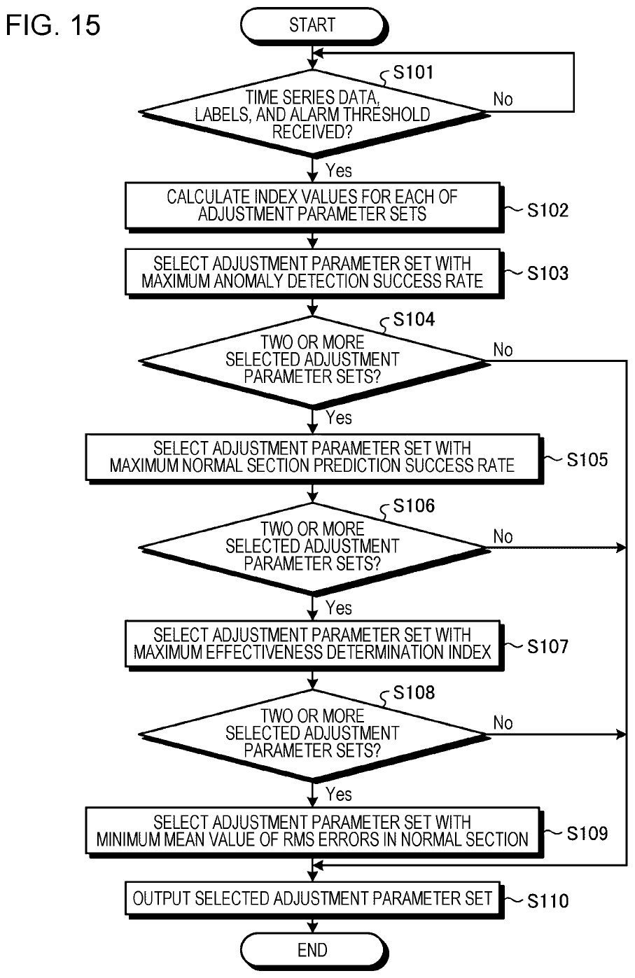

Processing procedures in the information processing apparatus 10 according to Embodiment 1 will be described below with reference to FIG. 15. FIG. 15 is a flowchart illustrating an example of the processing procedures according to Embodiment 1. Note that FIG. 15 illustrates an example of the processing procedures in the information processing apparatus according to Embodiment 1, and that a series of the processes can be executed while the order of the processes is partly exchanged, because S103, S105, S107, and S109 are independent of one another.

In the example of FIG. 15, the information processing apparatus 10 receives the input of the time series data, the labels, and the alarm threshold (step S101). If the time series data, the labels, and the alarm threshold are not received (step S101; No), the information processing apparatus 10 waits until the time series data, the labels, and the alarm threshold are received.

On the other hand, if the information processing apparatus 10 receives the time series data, the labels, and the alarm threshold (step S101; Yes), the index value calculation module 12a calculates the index values for each of the adjustment parameter sets to be searched (step S102). Then, the parameter determination module 12b selects the adjustment parameter set with, for example, the maximum anomaly detection success rate (S103). Then, the parameter determination module 12b determines whether there are two or more selected adjustment parameter sets (step S104).

If the number of the selected adjustment parameter sets is not two or more (step S104; No), the information processing apparatus 10 outputs the selected adjustment parameter set (step S110). On the other hand, if the number of the selected adjustment parameter sets is two or more (step S104; Yes), the parameter determination module 12b selects, from those selected adjustment parameter sets, the adjustment parameter set with the maximum normal section prediction success rate (step S105). Then, the parameter determination module 12b determines whether there are two or more selected adjustment parameter sets (step S106).

If the number of the selected adjustment parameter sets is not two or more (step S106; No), the information processing apparatus 10 outputs the selected adjustment parameter set (step S110). On the other hand, if the number of the selected adjustment parameter sets is two or more (step S106; Yes), the parameter determination module 12b selects, from those selected adjustment parameter sets, the adjustment parameter set with the maximum effectiveness determination index (step S107). Then, the parameter determination module 12b determines whether there are two or more selected adjustment parameter sets (step S108).

If the number of the selected adjustment parameter sets is not two or more (step S108; No), the information processing apparatus 10 outputs the selected adjustment parameter set (step S110). On the other hand, if the number of the selected adjustment parameter sets is two or more (step S108; Yes), the parameter determination module 12b selects, from those selected adjustment parameter sets, the adjustment parameter set with the minimum mean value of the RMS errors in the normal section (step S109). Then, the information processing apparatus 10 outputs the selected adjustment parameter set (step S110).

### 5. Advantageous Effects of Embodiment 1

As described above, the information processing apparatus 10 according to Embodiment 1 calculates the index values for each of the candidate adjustment parameter sets at all the time points within the evaluation target for the given time series data. Then, the information processing apparatus 10 selects the adjustment parameter set providing the proper prediction result based on both the above calculated index values and the index values of the adjustment parameter sets (the neighborhood adjustment parameter sets) in each of which the numerical value of one of the elements in the adjustment parameter set is changed to adjacent one among the candidates that are set as the numerical values of the one element, and outputs the selected adjustment parameter set to the outside.

With the above-described feature, the information processing apparatus 10 has the advantageous effect that, since the index values of the neighborhood adjustment parameter sets are added to the evaluation target in evaluating the adjustment parameter sets, determination of an improper adjustment parameter set attributable to unexpected abnormal data can be avoided.

Furthermore, the index value calculation module 12a in the information processing apparatus 10 calculate, as the index values, the root mean square error between the predicted value corresponding to a time point in the past data, the time point being a reference in the calculation of the predicted value, and the past actual data, the difference between the predicted value corresponding to the time point and the preset threshold, the anomaly detection success rate that is the ratio of one or more anomaly prediction sections each including the time point corresponding to the predicted value, for which the anomaly prediction has succeeded, to all the anomaly prediction sections in the past data, and the normal section prediction success rate that is the ratio of the number of the time points corresponding to the predicted values, for which normal prediction has succeeded, to the total number of the time points in one or more normal sections of the past data.

With the above-described feature, the information processing apparatus 10 has the advantageous effect that it can properly perform the anomaly prediction and the normal prediction in the selection of the adjustment parameter sets, can efficiently select the optimum adjustment parameter set with a small error between the actual data and the predicted value, and can output the optimum adjustment parameter set to the outside.

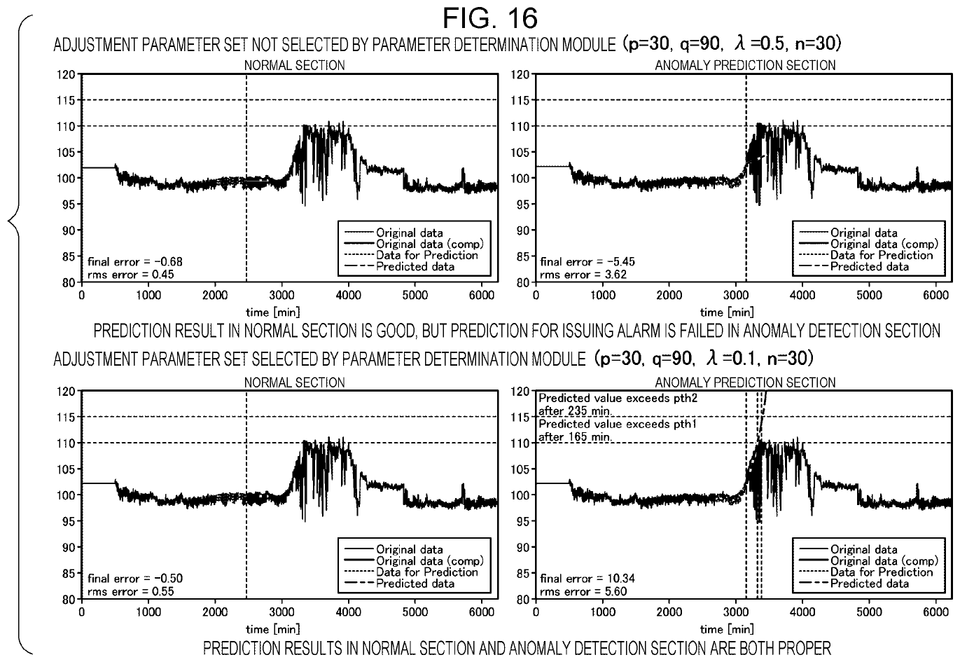

Results of prediction by the autoregression model 20 in the cases of using the adjustment parameter set selected through the above-described processes and the adjustment parameter set not selected will be described below with reference to FIG. 16. FIG. 16 illustrates an example of the results of the predictions with the information processing according to Embodiment 1.

In the example of FIG. 16, the autoregression model 20 calculates the predicted values for the time series data by using two adjustment parameter sets, namely the adjustment parameter set selected by the information processing apparatus 10 and a comparative adjustment parameter set not selected by the information processing apparatus 10.

The information processing apparatus 10 successively executes, for the time series data, the calculation of the index values (Processing 1), the selection of the adjustment parameter set with the maximum anomaly detection success rate (Processing 2), the selection of the adjustment parameter set with the maximum normal section prediction success rate (Processing 3), the selection of the adjustment parameter set with the maximum effectiveness determination index (Processing 4), and the selection of the adjustment parameter set with the minimum mean value of the RMS errors (Processing 5) (see FIG. 9).

The adjustment parameter set selected through the above-described series of the processes is (p, q, λ, n)=[30, 90, 0.1, 30]. Moreover, in the example of FIG. 16, a prediction result in accordance with the adjustment parameter set (p, q, λ, n)=[30, 90, 0.5, 30] not selected by the information processing apparatus 10 is used as the comparison target.

Four graphs are depicted in the example of FIG. 16. Of those four graphs, upper two graphs represent the prediction results in accordance with the not-selected adjustment parameter set, namely the comparison target, and lower two graphs represent the prediction results in accordance with the selected adjustment parameter set. Left two graphs in FIG. 16 represent the prediction results in the normal sections, and right two graphs represent the prediction results in the anomaly prediction sections. Moreover, in the example of FIG. 16, a value of 110 in the vertical axis in each graph is set as the alarm threshold.

Regarding the prediction result (upper left in FIG. 16) in the normal section when the adjustment parameter set (p, q, A, n)=[30, 90, 0.5, 30] not selected by the information processing apparatus 10 is used, a one-dot-chain line representing the predicted value does not exceed the alarm threshold. Thus, it can be said that the prediction in the normal section is properly performed. Regarding the prediction result (upper right in FIG. 16) in the anomaly prediction section, a one-dot-chain line representing the predicted value does not exceed the alarm threshold, and the anomaly prediction is failed. Thus, it cannot be said that the prediction is properly performed.

On the other hand, regarding the prediction result (lower left in FIG. 16) in the normal section when the adjustment parameter set (p, q, λ, n)=[30, 90, 0.1, 30] selected by the information processing apparatus 10 is used, a one-dot-chain line representing the predicted value does not exceed the alarm threshold. Thus, it can be said that the prediction in the normal section is properly performed. Regarding the prediction result (lower right in FIG. 16) in the anomaly prediction section, a one-dot-chain line representing the predicted value exceeds the alarm threshold. Thus, it can be said that the anomaly prediction has succeeded and the prediction is properly performed.

Stated another way, the autoregression model 20 has failed in properly performing the prediction in the anomaly prediction section when the adjustment parameter set not selected by the information processing apparatus 10 is used, but has succeeded in properly performing the prediction in both the normal section and the anomaly prediction section when the adjustment parameter set selected by the information processing apparatus 10 is used. Accordingly, it can be said that the adjustment parameter set (p, q, λ, n)=[30, 90, 0.1, 30] selected by the information processing apparatus 10 is the adjustment parameter set enabling the autoregression model 20 to more properly execute the prediction than the adjustment parameter set of the comparison target. It can also be said that the information processing apparatus 10 can select the appropriate adjustment parameter set by executing Processing 1 to Processing 5 which are an example of the information processing according to Embodiment 1.

### Embodiment 2

### 1. Outline of Information Processing Method

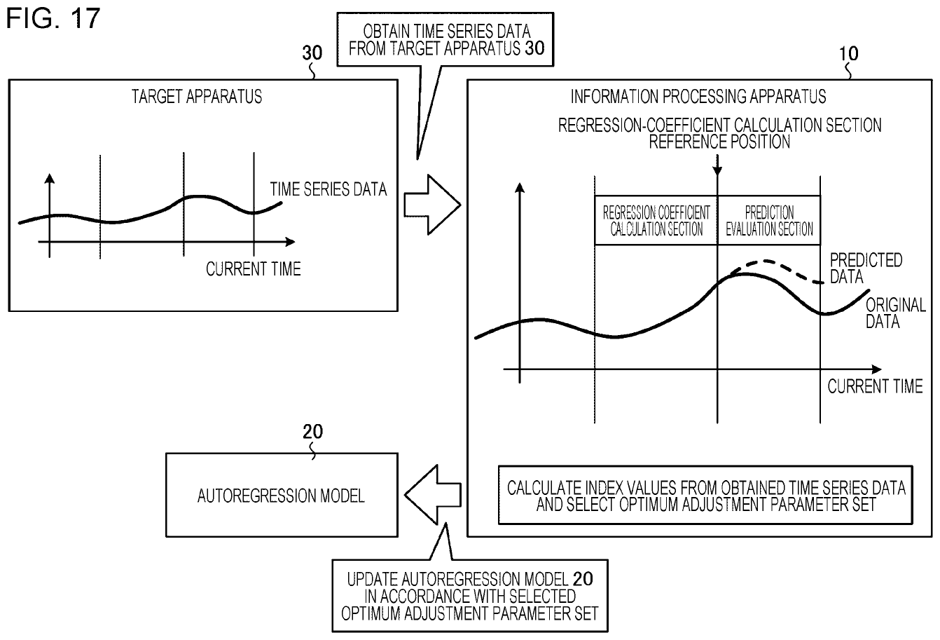

An outline of an information processing method executed by an information processing apparatus 10 according to Embodiment 2 is first described with reference to FIG. 17. FIG. 17 is an explanatory view illustrating the outline of the information processing method according to Embodiment 2. The description with reference to FIG. 17 is made about an example of information processing when the time series data is obtained from a target apparatus 30, the optimum adjustment parameter set is selected based on the index values calculated from the obtained time series data, and the autoregression model 20 is updated in accordance with the selected adjustment parameter set.

In the example illustrated in FIG. 17, the information processing apparatus 10 selects the optimum adjustment parameter set in response to input of the time series data from the target apparatus 30 and updates the autoregression model 20 in accordance with the selected adjustment parameter set. The information processing apparatus 10 is implemented by, for example, a computer or a cloud system.

The information processing apparatus 10 calculates the index values for all candidate adjustment parameter sets with respect to a regression-coefficient calculation section reference position (reference time), described later, based on the time series data obtained from the target apparatus 30, selects the optimum adjustment parameter set based on the calculated index values, and updates the autoregression model 20 in accordance with the selected adjustment parameter set.

In more detail, the information processing apparatus 10 first obtains, from the target apparatus 30, the time series data that is a prediction target. For instance, the information processing apparatus 10 obtains the time series data by receiving observation data transmitted from the target apparatus 30 in real time.

Then, the information processing apparatus 10 calculates the index values from the obtained time series data and selects the optimum adjustment parameter set. For instance, the information processing apparatus 10 calculates predicted data for all the candidate adjustment parameter sets in a prediction evaluation section with a current time being an evaluation reference position, derives a mean RMS error (described later) for each of the adjustment parameter sets, and then selects the adjustment parameter set with a minimum mean RMS error.

Finally, the information processing apparatus 10 updates the autoregression model 20 in accordance with the selected adjustment parameter set. For instance, the information processing apparatus 10 inputs the selected adjustment parameter set to the autoregression model 20 and updates the autoregression model 20 such that the predicted data is calculated using the regression coefficients updated in accordance with the input adjustment parameter set.

As described above, the information processing apparatus 10 calculates the index values in response to the input of the time series data and selects the optimum adjustment parameter set. Then, the information processing apparatus 10 updates the autoregression model 20 in accordance with the selected adjustment parameter set. As a result, the information processing apparatus 10 can cause the autoregression model 20 to execute the prediction with high accuracy by using the optimum adjustment parameter set in the calculation of the predicted value.

### 2. Configuration of Information Processing Apparatus 10

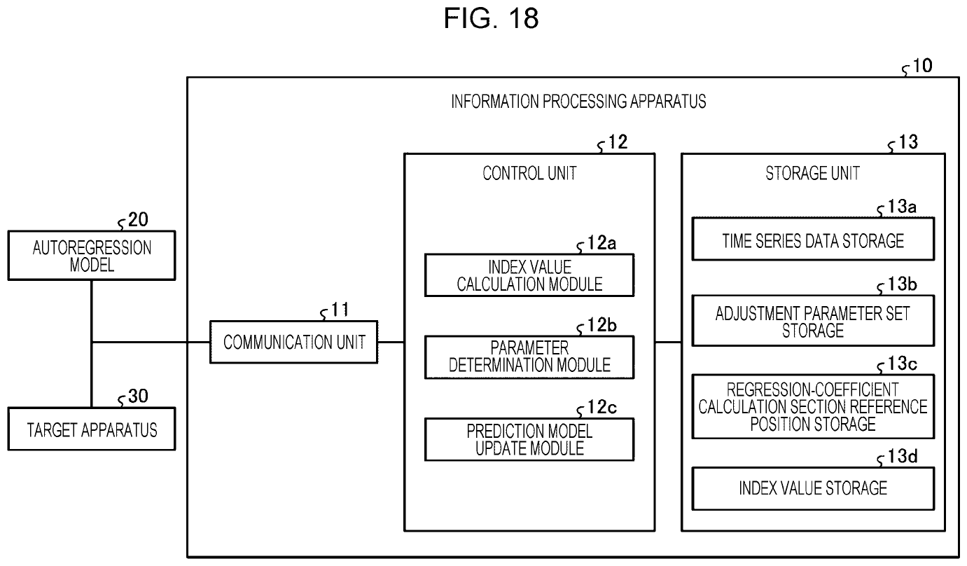

A configuration of the information processing apparatus 10 according to Embodiment 2 will be described below with reference to FIG. 18. FIG. 18 illustrates an example of the configuration of the information processing apparatus 10 according to Embodiment 2. As illustrated in FIG. 18, the information processing apparatus 10 according to Embodiment 2 includes a communication unit 11, a control unit 12, and a storage unit 13. The information processing apparatus 10, the autoregression model 20, and the target apparatus 30 are connected to be able to communicate with one another by wire or wirelessly.

The communication unit 11 is implemented by, for example, an NIC (Network Interface Card). The communication unit 11 is connected to the autoregression model 20 and the target apparatus 30 by wire or wirelessly to transmit and receive information to and from the autoregression model 20 and the target apparatus 30. For instance, input of the time series data from the target apparatus 30 and update of the autoregression model 20 in accordance with the selected adjustment parameter set are performed via the communication unit 11.

The storage unit 13 is implemented by, for example, a storage device such as a RAM (Random Access Memory) or a hard disk. The storage unit 13 stores data and programs necessary in various processes executed by the control unit 12. The storage unit 13 includes a time series data storage 13a, an adjustment parameter set storage 13b, a regression-coefficient calculation section reference position storage 13c, and an index value storage 13d as examples that are especially closely related to the present disclosure.

The time series data storage 13a stores time series data obtained by monitoring the target apparatus 30 in time series. For instance, the time series data storage 13a stores data recording a measured value, such as a temperature of the target apparatus 30, which is obtained by monitoring the target apparatus 30 in time series and which is input via the communication unit 11, together with a time of the measurement.

The adjustment parameter set storage 13b stores candidate adjustment parameter sets to be searched. For instance, the adjustment parameter set storage 13b stores combinations of adjustment parameter sets that become candidates in an adjustment parameter set selection process (described later).

The regression-coefficient calculation section reference position storage 13c stores information capable of specifying a regression-coefficient calculation section reference position that becomes a reference for a section for calculation of the regression coefficients, the reference being used to calculate the predicted data. For instance, the regression-coefficient calculation section reference position storage 13c stores information instructing that a time before an arbitrary period of time from a current time of the obtained time series data is set as the regression-coefficient calculation section reference position.

Here, the information processing apparatus 10 sets a section on a side closer to the current time than the regression-coefficient calculation section reference position as the prediction evaluation section and sets a section on a past side relative to the regression-coefficient calculation section reference position as a regression-coefficient calculation section (see FIG. 17). In other words, the information processing apparatus 10 evaluates, in the prediction evaluation section, the predicted data at the regression-coefficient calculation section reference position. A section width of the prediction evaluation section is set in advance, and a section width of the regression-coefficient calculation section is determined depending on elements of the adjustment parameter set. Moreover, information regarding the above-described candidate adjustment parameter sets and regression-coefficient calculation section reference position needs to be stored in advance before the selection of the optimum adjustment parameter set is started by the control unit 12.

The index value storage 13d stores various index values calculated by an index value calculation module 12a described later. For instance, the index value storage 13d stores the index values calculated for all the candidate adjustment parameter sets with respect to the regression-coefficient calculation section reference position in the obtained time series data.

The control unit 12 is implemented by, for example, a CPU (Central Processing Unit) or an MPU (Micro Processing Unit) executing various programs, stored in the storages of the information processing apparatus 10, while a RAM is used as a working area. Alternatively, the control unit 12 is implemented by, for example, an integrated circuit such as an ASIC (Application Specific Integrated Circuit) or an FPGA (Field Programmable Gate Array). The control unit 12 includes the index value calculation module 12a and a parameter determination module 12b. The control unit 12 may further include a prediction model update module 12c as required.

The index value calculation module 12a calculates values of the preset indexes for each of the adjustment parameter sets to calculate the regression coefficients that are used to derive a predicted value from the past data. The index value calculation module 12a stores the calculated index values in the index value storage 13d.

For instance, the index value calculation module 12a calculates the index values for all the candidate adjustment parameter sets with respect to the regression-coefficient calculation section reference position in the time series data based on respective data stored in the time series data storage 13a, the adjustment parameter set storage 13b, and the regression-coefficient calculation section reference position storage 13c, and stores the calculated index values in the index value storage 13d.

Moreover, the index value calculation module 12a may calculate, as the index value, a root mean square (RMS) error between a predicted value corresponding to the regression-coefficient calculation section reference position and past actual data. The index value calculation module 12a stores the calculated RMS error in the index value storage 13d.

For instance, the index value calculation module 12a calculates the RMS error between the predicted value in the prediction evaluation section and the actual data for each of all the candidate adjustment parameter sets with respect to the regression-coefficient calculation section reference position and stores the calculated RMS errors in the index value storage 13d.

The parameter determination module 12b selects an appropriate adjustment parameter set based on the index values calculated for each of the adjustment parameter sets and the index values of neighborhood adjustment parameter sets with respect to the interested each adjustment parameter set. Then, the parameter determination module 12b notifies the selected adjustment parameter set to the prediction model update module 12c.

The parameter determination module 12b repeats a predetermined number of times a step of calculating, as the index values of the neighborhood adjustment parameter sets, index values for each of the adjustment parameter sets by setting a past predetermined regression-coefficient calculation section reference position and by using data in a predetermined section with the regression-coefficient calculation section reference position being a reference, a step of changing the regression-coefficient calculation section reference position, and a step of calculating index values for each of the adjustment parameter sets by using data in a predetermined section with the changed regression-coefficient calculation section reference position being a reference. Then, the parameter determination module 12b selects the adjustment parameter set based on the calculated index values.

Here, the regression-coefficient calculation section reference position storage 13c stores, for example, not only information instructing that the time before an arbitrary period of time from the current time of the obtained time series data is set as the regression-coefficient calculation section reference position, but also information instructing that a time after changing the regression-coefficient calculation section reference position is also set as the regression-coefficient calculation section reference position. Thus, even when the regression-coefficient calculation section reference position is changed, the index value calculation module 12a can calculate the index values with the regression-coefficient calculation section reference position after the change being a reference and can store the calculated index values in the index value storage 13d.

For instance, the parameter determination module 12b selects the adjustment parameter set with a minimum value of the mean RMS error that is calculated based on both the RMS error for each of the candidate adjustment parameter sets at the predetermined regression-coefficient calculation section reference position and the RMS errors of the adjustment parameter sets (the neighborhood adjustment parameter sets) at regression-coefficient calculation section reference positions obtained after changing the predetermined regression-coefficient calculation section reference position toward a past side a predetermined number of times, both the above-mentioned RMS errors being stored in the index value storage 13d. Then, the parameter determination module 12b notifies the selected adjustment parameter set to the prediction model update module 12c.

The prediction model update module 12c updates the regression coefficients of the future prediction model in accordance with the adjustment parameter set selected by the parameter determination module 12b. For instance, in response to the notification of the adjustment parameter set from the parameter determination module 12b, the prediction model update module 12c updates the regression coefficients by updating parameters of the autoregression model 20 via the communication unit 11.

### 3. Specific Example of Information Processing

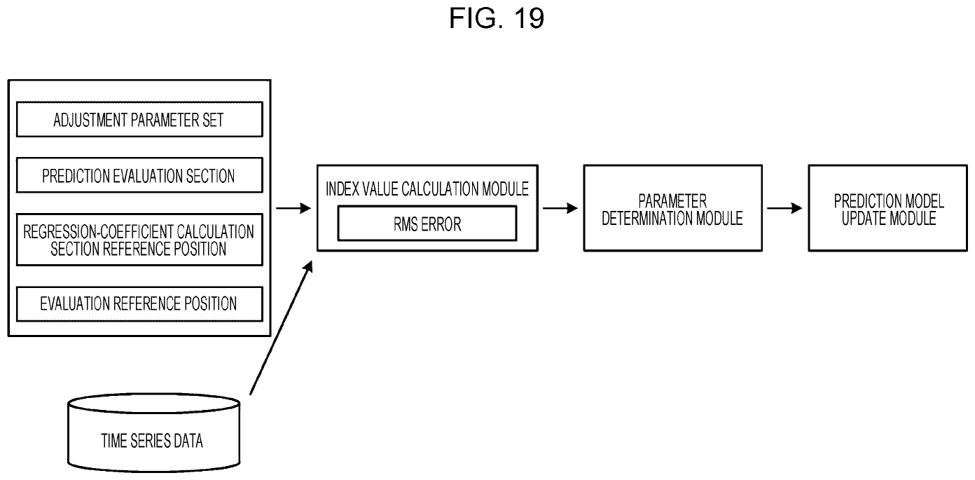

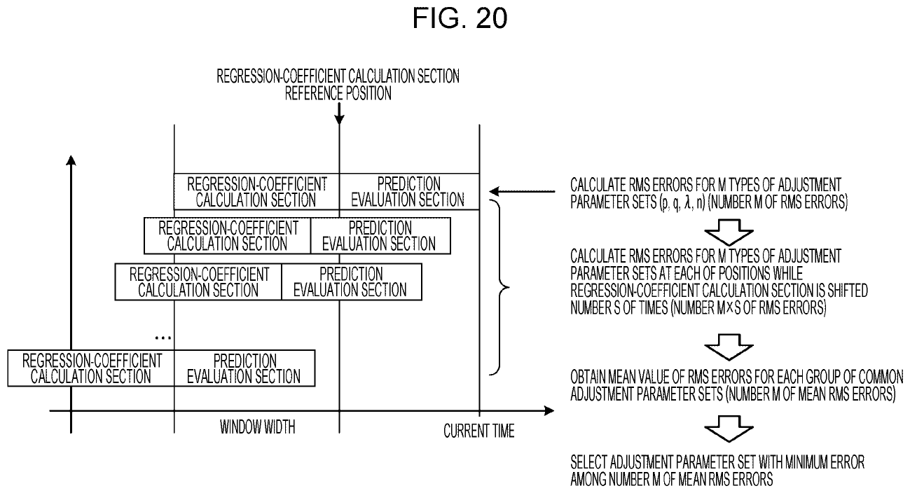

A specific example of the information processing according to Embodiment 2 will be described below with reference to FIGS. 19 and 20. FIG. 19 illustrates an overall system flow in the specific example of the information processing according to Embodiment 2. FIG. 20 illustrates an example of a method of calculating the mean RMS error in the specific example of the information processing according to Embodiment 2. In the following, after describing the flow of the information processing in the information processing apparatus 10, a specific example of a mean RMS error calculation process is described.

### 3-1. Flow of Information Processing

The overall system flow in the specific example of the information processing apparatus 10 is first described with reference to FIG. 19. For instance, in the information processing apparatus 10, the candidate adjustment parameter sets, the information regarding the regression-coefficient calculation section reference position, the information regarding the section width of the prediction evaluation section, and the information for specifying the current time serving as the evaluation reference position from the obtained time series data are stored in the storage unit 13 in advance.

Upon receiving the time series data from the target apparatus 30, the information processing apparatus 10 specifies the current time of the time series data as the evaluation reference position based on the information stored in the storage unit 13. Then, the index value calculation module 12a calculates the mean RMS error, described later, for each of the candidate adjustment parameter sets.

The parameter determination module 12b selects the adjustment parameter set with, for example, the minimum RMS error among the mean RMS errors of the individual adjustment parameter sets, those mean RMS errors being stored in the index value storage 13d, and notifies the selected adjustment parameter set to the prediction model update module 12c. Then, the prediction model update module 12c updates the parameters of the autoregression model 20 in accordance with the notified adjustment parameter set.

### 3-2. Mean RMS Error Calculation Process

The method of calculating the mean RMS error in the specific example of the information processing according to Embodiment 2 will be described below with reference to FIG. 20. First, the index value calculation module 12a calculates an RMS error for each of M types of adjustment parameter sets stored in the adjustment parameter set storage 13b by using the time series data in a predetermined section (regression coefficient calculation section in FIG. 20) with the regression-coefficient calculation section reference position being a reference.

Then, the index value calculation module 12a shifts the regression-coefficient calculation section to a past time an arbitrary number S of times and calculates RMS errors for each of the M types of adjustment parameter sets at each of individual regression-coefficient calculation section reference positions. In other words, the index value calculation module 12a calculates the number (M×S) of RMS errors because of the M types of adjustment parameter sets×the number S of regression coefficient calculation sections.

Thereafter, the index value calculation module 12a calculates a mean value of the RMS errors for each group of common adjustment parameter sets. Because of having calculated the number S of RMS errors for each of the M types of adjustment parameter sets in the above-described processing, the index value calculation module 12a can calculate a mean value of the RMS errors for each of the M types of adjustment parameter sets by calculating a mean value of the number S of RMS errors. In other words, the index value calculation module 12a calculates the number M of mean RMS errors. The index value calculation module 12a stores the calculated mean RMS errors in the index value storage 13d.

Finally, the parameter determination module 12b selects the adjustment parameter set with the minimum one among the mean RMS errors that are stored in the index value storage 13d through the above-described series of the processes executed by the index value calculation module 12a. As a result, the parameter determination module 12b can select the adjustment parameter set corresponding to a time at which an error between the actual data and the predicted data in the prediction evaluation section is minimum.

### 4. Processing Procedures

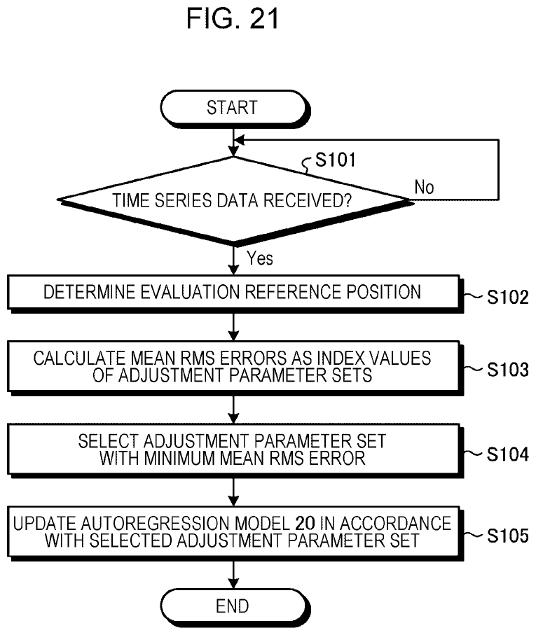

Processing procedures in the information processing apparatus 10 according to Embodiment 2 will be described below with reference to FIG. 21. FIG. 21 is a flowchart illustrating an example of the processing procedures according to Embodiment 2. In the example illustrated in FIG. 21, the information processing apparatus 10 receives the input time series data (step S101). If the time series data is not received (step S101; No), the information processing apparatus 10 waits until the time series data is received.

On the other hand, if the information processing apparatus 10 receives the time series data (step S101; Yes), the information processing apparatus 10 determines the current time of the time series data as the evaluation reference position (step S102). Then, the index value calculation module 12a calculates, for example, the mean RMS errors that are the index values of the adjustment parameter sets (step S103). Thereafter, the parameter determination module 12b selects the adjustment parameter set with the minimum mean RMS error (step S104).

Thereafter, the parameter determination module 12b selects the adjustment parameter set with the minimum mean RMS error (step S104). Finally, the information processing apparatus 10 updates the autoregression model 20 in accordance with the selected adjustment parameter set (step S105).

### 5. Advantageous Effects of Embodiment 2

As described above, the information processing apparatus 10 according to Embodiment 2 calculates the index values for all the candidate adjustment parameter sets with respect to the regression-coefficient calculation section reference position based on the time series data obtained from the target apparatus 30. Then, the information processing apparatus 10 selects the adjustment parameter set based on both the index values calculated above and the index values calculated for each of the adjustment parameter sets (the neighborhood adjustment parameter sets) that are obtained when the regression-coefficient calculation section reference position is changed the predetermined number of times and the changed regression-coefficient calculation section reference position is set as a reference.

With the above-described feature, the information processing apparatus 10 has the advantageous effect that, since the index values of the neighborhood adjustment parameter sets are added to the evaluation target in evaluating the adjustment parameter sets, determination of an improper adjustment parameter set attributable to unexpected abnormal data can be avoided.

Furthermore, the index value calculation module 12a of the information processing apparatus 10 calculates, as the index value, the RMS error between the predicted value corresponding to each regression-coefficient calculation section reference position and the past actual data for each of the adjustment parameter sets. Then, the prediction model update module 12c of the information processing apparatus 10 updates the regression coefficients by updating the parameters of the autoregression model 20 in accordance with the adjustment parameter set selected by the parameter determination module 12b.

With the above-described feature, the information processing apparatus 10 can select, through the adjustment parameter set selection process, the optimum adjustment parameter set with a small error between the actual data and the predicted data and can update the autoregression model 20 in accordance with the optimum adjustment parameter set. As a result, the autoregression model 20 can execute proper prediction with the regression coefficients calculated by using the optimum adjustment parameter set.

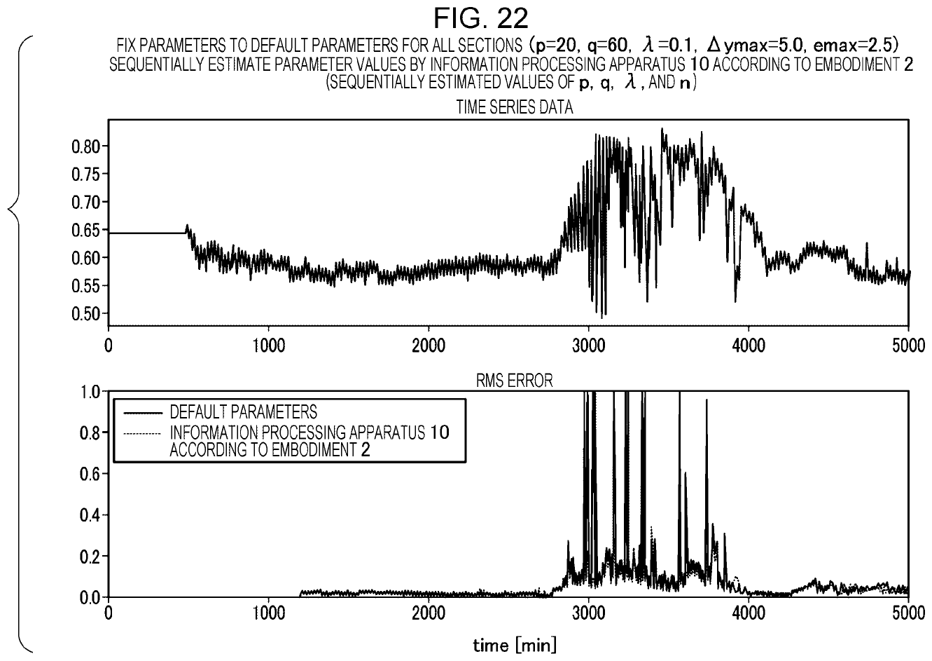

Prediction results of the autoregression model 20 when the adjustment parameter set selected through the above-described processing and when default parameters are used will be described below with reference to FIG. 22. FIG. 22 illustrates an example of the prediction result obtained with the information processing according to Embodiment 2. In the example of FIG. 22, the RMS error between the predicted value and the actual data in each of the above-mentioned cases is depicted to indicate accuracy of the predicted value.

In the example of FIG. 22, (p=20, q=60, λ=0.1, Δymax=5.0, emax=2.5) is used as the default parameters. The autoregression model 20 calculates, for an entire section of the time series data as a prediction target, predicted values when parameters are sequentially estimated with the adjustment parameter set selected by the information processing apparatus 10, and prediction values when the default parameters as a comparison target are used.

In the information processing apparatus 10, first, the index value calculation module 12a calculates the mean RMS errors for the obtained time series data, and the parameter determination module 12b selects the adjustment parameter set based on the calculated mean RMS errors. Then, the prediction model update module 12c of the information processing apparatus 10 updates the parameters of the autoregression model 20 in accordance with the selected adjustment parameter set.

In the example of FIG. 22, the information processing apparatus 10 obtains the time series data from the target apparatus 30 at constant intervals and executes the above-described processing whenever the time series data is obtained. Accordingly, the parameters of the autoregression model 20 are sequentially updated in response to the receipt of the time series data by the information processing apparatus 10.

In the example of FIG. 22, the prediction result (solid line in FIG. 22) when the default parameters as the comparison target are used indicates that the RMS error representing the error between the prediction result and the actual data is increased in a range between 3000 min and 4000 min where the measured value of the actual data highly fluctuates. In other words, when the default parameters as the comparison target are used, the autoregression model 20 calculates the predicted value with a large error relative to the actual data in a certain section. Thus, it cannot be said that the prediction is properly performed.

By contrast, the prediction result (dotted line in FIG. 22) when the parameters of the autoregression model 20 are sequentially updated in accordance with the adjustment parameter set selected by the information processing apparatus 10 indicates that the RMS error of the predicted value is relatively small even in the range between 3000 min and 4000 min where the measured value of the actual data highly fluctuates. In other words, when the parameters of the autoregression model 20 are sequentially updated according to the information processing apparatus 10, the autoregression model 20 calculates the predicted value with a small error relative to the actual data in the entire section of the target time series data. Thus, it can be said that the prediction is properly performed.

Consequently, it can be said that, when the parameters of the autoregression model 20 are sequentially estimated in accordance with the adjustment parameter set selected by the information processing apparatus 10, the autoregression model 20 can more properly execute the prediction than when the default parameters as the comparison target are used.

Furthermore, comparing the prediction results in the above-mentioned two cases when the time series data is given as sine waves with different frequencies, a sine wave with noise gradually increasing, and a sine wave with a varying frequency, it is confirmed for all the time series data that the autoregression model 20 more properly executes the prediction when the parameters of the autoregression model are sequentially estimated by the information processing apparatus 10. This can be said as indicating that the information processing apparatus 10 can select the proper adjustment parameter set by executing the series of the processes described above as one example of the information processing according to Embodiment 2.

### Hardware Configuration

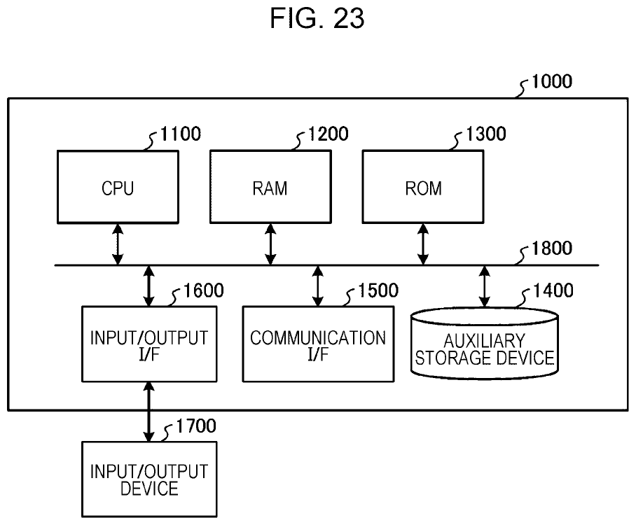

The above-described information processing apparatuses according to Embodiments 1 and 2 are implemented by, for example, a computer 1000 with a configuration illustrated in FIG. 23. FIG. 23 is a hardware block diagram illustrating an example of the computer implementing the function of the information processing apparatus 10. In the computer 1000, a CPU 1100, a RAM 1200, a ROM 1300, an auxiliary storage device 1400, a communication I/F (interface) 1500, and an input/output I/F (interface) 1600 are connected to one another by a bus 1800.

The CPU 1100 is operated in accordance with programs stored in the ROM 1300 or the auxiliary storage device 1400 and controls the individual units. The ROM 1300 stores a boot program executed by the CPU 1100 at startup of the computer 1000, various programs depending on hardware of the computer 1000, and so on.

The auxiliary storage device 1400 stores the programs executed by the CPU 1100, data used in execution of those programs, and so on. The communication I/F 1500 receives data from other devices via a predetermined communication network, sends the received data to the CPU 1100, and transmits data generated by the CPU 1100 to other devices via a predetermined communication network.

The CPU 1100 controls an output device, such as a display or a printer, and an input/output device 1700, such as a keyboard or a mouse, through the input/output I/F 1600. The CPU 1100 obtains data from the input/output device 1700 through the input/output I/F 1600. In addition, the CPU 1100 outputs the generated data to the input/output device 1700 through the input/output I/F 1600.

In an example, when the computer 1000 functions as the information processing apparatuses 10 according to Embodiments 1 and 2, the CPU 1100 of the computer 1000 implements the function of the control unit 12 by executing the program loaded on the RAM 1200.

### Others

Among the various processes described above in Embodiments 1 and 2, all or part of the processes described as being automatically executed can also be manually executed, or all or part of the processes described as being manually executed can also be automatically executed by one or more known methods. Furthermore, the information including the processing procedures, the specific names, and the various data and parameters, which are explained in the above description and the drawings, can be optionally changed unless otherwise specified. For instance, various items of information explained in the drawings are not limited to those ones.

The above description of individual components of the illustrated apparatuses are conceptual in a functional point of view, and those components are not always required to be physically constituted as per illustrated. Stated another way, specific embodiments corresponding to separated or integrated forms of the components of the apparatuses are not limited to the illustrated ones, and all or part of the components of the apparatuses can be functionally or physically separated or integrated per optional unit of the demanded configuration depending on various loads, situations of use, and so on.

The above-mentioned components are to be interpreted as include components easily conceivable by those skilled in the art and substantially the same components, namely components falling within the scope of the so-called equivalents. Moreover, the above-described Embodiments 1 and 2 can be combined with each other as appropriate insofar as no contradictions are caused in content of processing.

The word “module” and “unit” used in the above description can be read as, for example, “means” or “circuit”. For instance, the control unit can be read as control means or a control circuit.

While several embodiments of the present disclosure have been described in detail with reference to the drawings, those embodiments are merely illustrative, and the present disclosure can be implemented not only in the embodiments disclosed in the above detailed description, but also in other embodiments that are variously modified or improved based on the knowledges of those skilled in the related art.

What is claimed is:

1. An information processing apparatus comprising:
an index value calculation module that calculates values of preset indexes for each of adjustment parameter sets to calculate regression coefficients which are used to derive a predicted value from past data; and
a parameter determination module that selects an appropriate adjustment parameter set based on the index values calculated for each of the adjustment parameter sets and index values of neighborhood adjustment parameter sets with respect to the interested each adjustment parameter set.

2. The information processing apparatus according to claim 1, wherein the parameter determination module selects the appropriate adjustment parameter set based on the index values of adjustment parameter sets in each of which a numerical value of one of elements in the adjustment parameter set is changed to adjacent one among candidates that are set as numerical values of the one element, those adjustment parameter sets being given as the neighborhood adjustment parameter sets.

3. The information processing apparatus according to claim 2, wherein the index value calculation module calculates, as the index values,
a root mean square error between a predicted value corresponding to a time point in the past data, the time point being a reference in calculation of the predicted value, and past actual data,
a difference between the predicted value corresponding to the time point and a preset threshold,
an anomaly detection success rate that is a ratio of one or more anomaly prediction sections each including the time point corresponding to the predicted value, for which anomaly prediction has succeeded, to all the anomaly prediction sections in the past data, and
a normal section prediction success rate that is a ratio of the number of the time points corresponding to the predicted values, for which normal prediction has succeeded, to the total number of the time points in one or more normal sections of the past data.

4. The information processing apparatus according to claim 1, wherein the parameter determination module repeats a predetermined number of times a step of calculating, as the index values of the neighborhood adjustment parameter sets, index values for each of the adjustment parameter sets by setting a past predetermined reference time and by using data in a predetermined section with the past predetermined reference time being a reference, a step of changing the reference time, and a step of calculating index values for each of the adjustment parameter sets by using data in a predetermined section with the changed reference time being a reference, and selects the appropriate adjustment parameter set based on the calculated index values.

5. The information processing apparatus according to claim 4,
wherein the index value calculation module calculates, as the index value, a root mean square error between the predicted value calculated by using data in the predetermined section with the reference time being a reference and past actual data, and
the information processing apparatus further comprises a prediction model update module that updates the regression coefficients of a future prediction model in accordance with the adjustment parameter set selected by the parameter determination module.

6. An information processing method comprising an information processing step executed by an information processing apparatus, the information processing step comprising:
an index value calculation step of calculating values of preset indexes for each of adjustment parameter sets to calculate regression coefficients which are used to derive a predicted value from past data; and
a parameter determination step of selecting an appropriate adjustment parameter set based on the index values calculated for each of the adjustment parameter sets and index values of neighborhood adjustment parameter sets with respect to the interested each adjustment parameter set.

7. An information processing program causing a computer to execute:
an index value calculation procedure of calculating values of preset indexes for each of adjustment parameter sets to calculate regression coefficients which are used to derive a predicted value from past data; and
a parameter determination procedure of selecting an appropriate adjustment parameter set based on the index values calculated for each of the adjustment parameter sets and index values of neighborhood adjustment parameter sets with respect to the interested each adjustment parameter set.
